(19) United States
(12) Patent Application Publication
(10) Pub. No.: US 2025/0350224 A1
(43) Pub. Date: Nov. 13, 2025

(54) DRIVE SYSTEM FOR AN ACTUATOR

(71) Applicant: Liebherr-Aerospace Lindenberg GmbH, Lindenberg (DE)

(72) Inventors: Frank KRONBURGER, Lindenberg (DE); Thomas IMMLER, Sigmarszell (DE); Julian KINZELMANN, Hergensweiler (DE)

(21) Appl. No.: 19/201,580

(22) Filed: May 7, 2025

(30) Foreign Application Priority Data
May 8, 2024 (DE) 10 2024 113 022.9

(51) Int. Cl. H02P 23/04

(52) U.S. Cl. CPC H02P 23/04

(57) ABSTRACT

The disclosure proposes a drive system for an actuator, comprising an electric motor for actuating the actuator, a first and second drive electronics unit designed to provide electric power to a motor connection for driving the electric motor, a first isolating device arranged between the first drive electronics unit and the motor connection and configured to selectively electrically isolate the first drive electronics unit from the motor connection, a second isolating device arranged between the second drive electronics unit and the motor connection and configured to selectively electrically isolate the second drive electronics unit from the motor connection, and a damping unit. The first drive electronics unit and the second drive electronics unit are redundant to each other. The damping unit is designed to detect the state of the first and second isolating devices and to cause damping of the electric motor when both are activated.

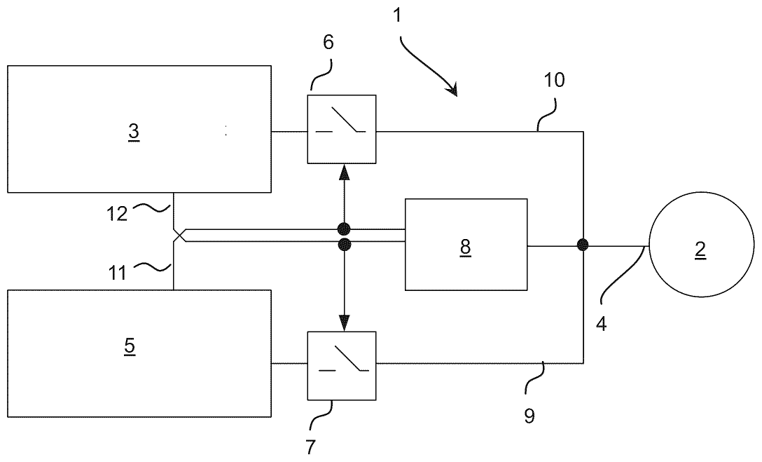

### CROSS REFERENCE TO RELATED APPLICATION

The present application claims priority to German Patent Application No. 10 2024 113 022.9 filed on May 8, 2024. The entire contents of the above-listed application are hereby incorporated by reference for all purposes.

### TECHNICAL FIELD

The present disclosure relates to a drive system for an actuator, in particular an electromechanical actuator.

### BACKGROUND

The drive system of an electromechanical actuator plays a crucial role in modern aviation technology, in particular in the primary flight control systems of aircraft. These actuators are responsible for the precise manipulation of control elements such as flaps, rudders and other critical components. They replace conventional hydraulic systems with a more efficient, lighter and often more reliable electromechanical solution.

### SUMMARY

A component of such a drive system is an electric motor that converts electrical energy directly into mechanical energy, which then supplies the necessary movement and force for actuating the control elements to be operated with the actuator via a transmission.

The implementation of redundant systems in critical components such as the drive systems of an aircraft's electromechanical actuators is an essential aspect of ensuring the highest safety standards. For this reason, it is common practice in aviation to design safety-critical actuators redundantly.

Conventionally, such redundancy is achieved by completely duplicating an electric drive train, wherein the parallel drive trains then run on a common transmission that is capable of decoupling a faulty drive train. The disadvantage of this is that an implementation with two mutually redundant drive trains is very expensive and requires a large installation volume.

Another problem is that in the case of a redundant implementation of the drive train, no precautions are taken in the event of a total failure of the two drive trains, so that, for example, in the case of an electromechanical actuator that actuates a flight control surface, this can lead to the flight control surface being set into an oscillation state due to vibration or externally acting flow conditions, which can lead to massive damage to the flight control surface itself, but also to damage to neighbouring structural components.

It is the aim of the present disclosure to create a drive system that overcomes or at least minimizes the disadvantages listed above. This is achieved with a drive system according to the subject matter described herein.

The drive system according to the disclosure comprises an electric motor for outputting a torque for actuating the actuator, a first drive electronics unit, which is designed to provide electric power to a motor connection for driving the electric motor, a second drive electronics unit, which is designed to provide electric power to the motor connection for driving the electric motor, a first isolating device, which is provided in a connection between the first drive electronics unit and the motor connection and, in an active state, electrically isolates the first drive electronics unit from the motor connection, a second isolating device, which is provided in a connection between the second drive electronics unit and the motor connection and, in an active state, electrically isolates the second drive electronics unit from the motor connection, and a damping unit, which is connected to the electric motor via the motor connection and which is designed to increase the movement resistance of the electric motor if required, wherein the first drive electronics unit and the second drive electronics unit are redundant to each other, and the damping unit is designed to detect the state of the first isolating device and the state of the second isolating device and to cause damping of the electric motor when both isolating devices are in their active state.

According to the disclosure, it is therefore provided that there is a first drive electronics unit and a second drive electronics unit, which are designed to be redundant to one another. The first drive electronics unit and/or the second drive electronics unit are designed to control the electric motor so that the drive system is designed redundantly with regard to the electrical part of the drive train by duplicating the corresponding components. In addition to this redundant design, a damping unit is also provided, which damps the movement of the electric motor if neither the first drive electronics unit nor the second drive electronics unit is able to control or regulate the motor via a corresponding electric power output to the motor connection. The damping unit is equipped with sensors that check the active or inactive status of a respective isolating device assigned to the drive electronics unit. If both the first isolating device, which is assigned to the first drive electronics unit, and the second isolating device, which is assigned to the second drive electronics unit, are in an active state, i.e. both drive electronics units are electrically isolated from the motor connection and therefore cannot control the motor, the damping unit damps the electric motor in order to prevent vibrations of the element to be controlled by the actuator.

The advantage of this is that the drive system according to the disclosure also considers the case when neither redundant drive electronics unit is able to control the electric motor any longer. In this case, the damping unit takes over and damps the electric motor so that vibrations of the element actuated by the actuator are suppressed.

According to an optional embodiment of the present disclosure, the first isolating device and the second isolating device can each be implemented by a switch that interrupts the electrical connection between the associated drive electronics and the motor connection of the electric motor as required. This ensures that if a drive unit outputs faulty signals to control the electric motor, these are no longer transmitted to the motor connection.

In addition, providing the isolating device is advantageous because the drive electronics that are not in operation, which are only used in the event of a fault in the drive electronics that are in operation, are also protected from any feedback from the first drive electronics or the motor connection by means of the isolating device. Finally, the isolating device of the drive electronics not used to operate the motor is also electrically separated or isolated from the motor connection using a switch or similar.

According to an embodiment of the present disclosure, it can therefore be provided that the first isolating device and the second isolating device are designed such that at least one of the first drive electronics unit and the second drive electronics unit is electrically isolated from the motor connection. As already indicated above, the implementation of the electrical isolating device by means of a switch can be provided.

According to another optional development of the present disclosure, it can be provided that the first drive electronics unit and the second drive electronics unit are each designed to switch between an active mode for controlling the electric motor and a control mode for monitoring the drive system, in particular the electric motor and/or the other drive electronics unit, wherein the control mode serves to monitor a fault-free state.

Optionally, one of the two drive electronics units is in an active mode and the other of the two drive electronics modes is in a control mode, so that it is not the case that both drive electronics units send signals to the electric motor at the same time. At least one of the two drive electronics units is electrically isolated from the electric motor by means of the two isolating devices, so that simultaneous transmission of control signals to the motor connection is not possible.

Optionally, it can be provided that the first drive electronics unit and the second drive electronics unit are each designed, in control mode, to activate the isolating device of the other drive electronics unit when a fault state is detected, and to switch to active mode in order to take over control of the electric motor.

In a control mode, although the drive electronics unit in the control mode are electrically isolated from the electric motor by an active state of the isolation device, each of the two drive electronics receives the same input signals regardless of which mode the drive electronics is in, so that a drive electronics unit in the control mode can monitor the drive electronics unit in the active mode. For example, the signals output by the drive electronics unit in active mode are compared and checked to see whether they match the signals that would have been output by the drive electronics unit in control mode based on the input signals received. If there is a deviation from this, the drive electronics unit in control mode can seek to switch to active mode, wherein the isolating device of the drive electronics unit deemed to be faulty is first switched to the active state and the isolating device of the drive electronics still in control mode is deactivated, so that the previously electrically isolated drive electronics are now connected to the motor connection of the electric motor. Therefore, if a drive electronics unit in control mode has detected a fault in the drive electronics unit in active mode, the drive electronics unit in control mode can be switched to a different mode, which simultaneously results in the drive electronics unit considered to be faulty being removed from the control of the electric motor by transferring the isolating device to the active state.

According to a further optional modification of the present disclosure, it can be provided that the first drive electronics unit and the second drive electronics unit are each designed, in active mode, to monitor themselves and activate the associated isolating device if a fault state is detected.

Optionally, in the event of a self-detected fault state of one drive electronics unit, a signal can also be sent to the other drive electronics unit to take over control of the electric motor, so that the drive electronics unit that is actually in control mode takes over control of the motor. However, if the other drive electronic unit has also detected a fault or if a fault has been detected by a higher-level control instance, it is possible that the other drive electronic unit will not comply with this request, so that the state occurs in which both drive electronic units are electrically isolated from the motor by their associated isolating device, so that no electrical power is supplied to the motor. Such a state is detected by the damping unit, which then damps the electric motor. In this way, it is also possible to provide for the case that both drive electronics units, which are designed redundantly to each other, fail or do not assume a completely fault-free state, but nevertheless an undamped state of an electromechanical actuator provided with the drive system unit according to the disclosure does not occur, as the electric motor driving the actuator is damped by the damping unit.

According to an embodiment of the present disclosure, it can be provided that the first drive unit and the second drive unit are linked with identical input signals for controlling the electric motor, which are used in a control mode to monitor the other drive unit in active mode, for example by calibrating a motor speed and/or a current value and/or voltage value supplied by the other drive unit to the motor connection.

Due to the redundant design, the drive electronics units provided are therefore supplied with the input signals to control the drive electronics unit even if the signals are not actually intended to be output to the electric motor, as the other drive electronics unit will take care of this. The reason for this is that the input signals to the redundant drive electronics are used to monitor the other drive electronics unit. The input signals are therefore processed as if the redundant drive electronics units were actually connected to the electric motor, so that a comparison can be made as to whether the control signals for the motor generated by the redundant drive electronics unit differ from the control signals of the other drive electronics unit. If this is the case, the redundant drive electronics unit can leave the control mode and switch to the active mode, wherein the other drive electronics are disconnected from a connection with the electric motor by transferring the associated isolating device (by signalling from the other drive electronics) to the active state.

According to a further optional development of the present disclosure, it can be provided that, in a fault-free state of the drive system, one drive electronics unit is in the active mode and the other drive electronics unit is in the control mode. This corresponds to a normal state of the drive system according to the disclosure, as one of the two drive electronics actually generates the signals that are fed to the electric motor and the other drive electronics unit is kept redundant and its connection to the motor connection of the electric motor is interrupted by means of the isolating device.

According to an embodiment of the present disclosure, it can be provided that the motor connection comprises a plurality of cables, which are connected to a respective phase of the electric motor.

Optionally, each of the two drive electronics units is designed to output a specific power signal for each phase of the motor, for example one that has a specific current value and a specific voltage value.

Optionally, it can be provided according to the disclosure that the electric motor is a permanent magnet synchronous motor or a brushless DC motor. The commutation of the electric motor corresponds to a standard commutation.

According to an embodiment of the present disclosure, the damping unit may be designed to short-circuit the phases of the motor in order to generate a resistance to a rotary movement of the motor. This allows simple implementation of damping during motor movement.

According to an embodiment of the present disclosure, the damping unit may be designed to switch the phases of the motor to an electrical or electronic load in order to generate a resistance to a rotary movement of the motor. This also allows simple implementation of damping during motor movement.

In addition, according to an embodiment of the present disclosure, the damping unit may be integrated in the electric motor.

The disclosure also relates to an electromechanical actuator having a drive system according to one of the aspects discussed above.

Thus, according to an optional modification of the present disclosure, the actuator may be designed for use in a primary flight control of an aircraft. For example, the actuator can be used to actuate an air guide surface of an aircraft, so that the advantages of the drive system according to the disclosure are particularly effective here.

In addition, the present disclosure relates to an aircraft having an electromechanical actuator according to one of the aspects discussed above.

### BRIEF DESCRIPTION OF THE FIGURE

Further features, details and advantages of the disclosure can be seen in the following description of the figures. In the drawings:

The FIGURE shows a schematic representation of a drive system for an actuator according to the disclosure.

### DETAILED DESCRIPTION

The FIGURE shows a schematic representation of the drive system 1 according to the disclosure.

The electric motor 2, which is used to operate an actuator, can be seen. In addition, a first drive electronics unit 3 and a second drive electronics unit 5 are provided, which are each designed to be redundant to one another. Each of the two drive electronics units 3, 5 is controlled via input signals (not shown) which, for example, sense the position of a controller in order to effect control of the actuator connected to the electric motor 2 corresponding to the controller position. In one example, the first drive electronics unit 3 and the second drive electronics unit 5 may each comprise a processor, memory, motor driver circuitry, and power switching components. The memory of each of the first drive electronics unit 3 and the second drive electronics unit 5 may store instructions executable by the respective processor to activate and deactivate each of the isolating devices 6, 7. For example, the instructions stored in memory of the first drive electronics unit 3 may cause the processor of the first drive electronics unit 3 to determine that the isolating device 6 is activated (e.g., the first drive electronics unit 3 is in control mode), process the input signals from the electric motor 2 to determine motor speed, current values, and/or voltage values, compare the determined motor speed, current values, and/or voltage values with the corresponding output of the second drive electronics unit 5, determine a deviation in the values indicating a fault in second drive electronics unit 5 in active mode, activate the isolating device 7 of the second drive electronics unit, and deactivate the isolating device 6 of the first drive electronics unit. In this way, the drive electronic unit in control mode may identify a fault and take over control of the electric motor 2 by switching itself to active mode and removing the other drive electronics unit from active mode.

For this purpose, each of the two drive electronics units 3, 5 is connected to a motor connection 4 of the electric motor 2. In order to minimize the number of cables, the electric motor connection 4 is only provided once and can receive corresponding signals from each of the two drive electronics units 3, 5 to control the electric motor 2. Accordingly, a signal for controlling the electric motor 2 is transmitted by the first drive electronics unit 3 via a cable 10, which is connected to a cable 9 is used to control the electric motor 2 by the second drive electronics unit 5.

However, to prevent divergent or double control of the electric motor 2 via the motor connection 4, an isolating device 6, 7 is provided in each of the cables 9, 10, which is designed to electrically isolate the associated drive electronics unit 3, 5. This can be realised, for example, by providing a switch that is moved to its open position so that the associated drive electronics unit 3, 5 are isolated. Thus, the isolating device 6, 7 may each be a switch.

In control mode, one of the two drive electronics units 3, 5 is responsible for controlling the electric motor 2, so that the drive electronics unit 3, 5 responsible for controlling the electric motor 2 must send corresponding control signals to the motor connection 4 of the electric motor 2. It is therefore provided that one of the two isolating devices 6, 7 is in its inactive state (e.g., the switch is closed), which allows signals output by an associated drive electronics unit 3, 5 to be conducted to the motor connection 4.

The isolating device 6, 7 associated with the other drive electronics unit 3, 5 is in its active state (e.g., the switch is open), and therefore such drive electronics unit 3, 5 can not act on the electric motor 2, as the signals actually intended for transmission to the motor connection 4 are not passed on due to the isolating device and the resulting electrical isolation.

In addition, the damping unit marked with the reference numeral 8, which is also connected to the motor connection 4 of the electric motor 2, can also be seen. If necessary, this can short-circuit the different phases of the electric motor 2 or connect them to each other via an electrical or electronic load, which has the effect of damping the electric motor 2. In some examples, the damping unit 8 is a dynamic electrical damping circuit. The damping unit 8 may comprise a processor and a memory containing instructions executable by the processor to detect the state of the first isolating device 6 and the state of the second isolating device 7 and to cause damping of the electric motor 2 when both isolating devices 6, 7 are in their active state. In some examples, the instructions may be executable by the processor to not damp the electric motor when either the first isolating device 6 or the second isolating device 7 is inactivated.

The damping unit 8 is designed to detect the state of the two isolating devices 6, 7 and to damp the electric motor 2 as a function thereof. Damping of the motor 2 is only carried out if the state is detected that both isolating devices 6, 7 are in their active state, which means that neither the first drive electronics 3 nor the second drive electronics 5 have an electrical connection to the motor connection 4 of the motor 2, i.e. the motor 2 does not receive any control signals. In order to prevent undesirable vibrations from occurring due to external influences, e.g. an air flow at an air guide element of an electromechanical actuator equipped with the drive system according to the disclosure, which could cause damage to components of the drive system or even neighbouring components in the integrated structure of the drive system, the damper unit has a damping effect on the motor 2.

The cables 11, 12, which run from one drive electronics unit 3, 5 to the isolating device 6, 7 of the other drive electronics unit 3, 5, can also be seen. Since it is clear that both drive electronics units 3, 5 cannot send control signals to a motor connection 4 of the motor 2 at the same time, there is one drive electronics unit 3, 5 that is in an active state and another drive electronics unit 3, 5 that is in a control mode.

In this control mode, the drive electronics units 3, 5 are electrically isolated from the motor connection 4 using the associated isolating device 6, 7, so that any outputs from the drive electronics unit 3, 5 are not passed on to the motor connection 4. However, each of the two drive electronics units 3, 5 is able to monitor the drive system in the control mode, in particular to monitor the drive electronics unit 3, 5 in active mode, the electric motor 2 or its parameters, such as rotational speed, torques or the like, or also the control signals output by the drive electronics unit 3, 5 in the active state.

If the drive electronics unit 3, 5 in control mode shows a deviation from the values it considers to be correct, the drive electronics unit 3, 5 in control mode can endeavour to switch to active mode and at the same time remove the drive electronics unit 3, 5 previously in active mode from the control of the electric motor 2. This is achieved by the drive electronics unit 3, 5 in control mode activating the isolating device 6, 7 of the other drive electronics unit 3, 5 and deactivating the other isolating device 6, 7, so that the drive electronics unit 3, 5 previously in control mode can now take over control of the motor 2.

If, on the other hand, faults are detected in both drive electronics units 3, 5, either by themselves, a higher-level control instance and/or the other drive electronics unit 3, 5, neither of the two drive electronics units 3, 5 is available for controlling the electric motor 2, so that the damping unit 8 detects an active state of the two isolating devices in 6, 7 and causes the motor 2 to be damped.

### LIST OF REFERENCE NUMERALS

1 Drive system
2 Electric motor
3 First drive electronics unit
4 Motor connection
5 Second drive electronics unit
6 First isolating device
7 Second isolating device
8 Damping unit
9 Cable(s) for controlling the motor of the second drive electronics unit
10 Cable(s) for controlling the motor of the first drive electronics unit
11 Cable of the second drive electronics unit for activating the first isolating device
12 Cable of the first drive electronics unit for activating the second isolating device

1. A drive system for an actuator, comprising:
an electric motor for outputting a torque for actuating the actuator,
a first drive electronics unit, which is designed to provide electric power to a motor connection for driving the electric motor,
a second drive electronics unit, which is designed to provide electric power to the motor connection for driving the electric motor,
a first isolating device, which is provided in a connection between the first drive electronics unit and the motor connection and, in an active state, electrically isolates the first drive electronics unit from the motor connection,
a second isolating device, which is provided in a connection between the second drive electronics unit and the motor connection and, in an active state, electrically isolates the second drive electronics unit from the motor connection, and
a damping unit, which is connected to the electric motor via the motor connection and which is designed to increase a movement resistance of the electric motor if required,
wherein the first drive electronics unit and the second drive electronics unit are redundant to each other, and
wherein the damping unit is designed to detect a state of the first isolating device and a state of the second isolating device and to cause damping of the electric motor when both isolating devices are in their active state.

2. The drive system according to claim 1, wherein the first isolating device and the second isolating device are designed such that at least one of the first drive electronics unit and the second drive electronics unit is electrically isolated from the motor connection at a given time.

3. The drive system according to claim 1, wherein the first drive electronics unit and the second drive electronics unit are each designed to switch between an active mode for controlling the electric motor and a control mode for monitoring the drive system, and wherein the control mode serves to monitor a fault-free state.

4. The drive system according to claim 3, wherein the first drive electronics unit and the second drive electronics unit are each designed, in the control mode, to activate the isolating device of the other drive electronics unit when a fault state is detected, and to switch to the active mode in order to take over control of the electric motor.

5. The drive system according to claim 3, wherein the first drive electronics unit and the second drive electronics unit are each designed, in the active mode, to monitor themselves and activate the associated isolating device if a fault state is detected.

6. The drive system according to claim 1, wherein the first drive electronics unit and the second drive electronics unit are linked with identical input signals for controlling the electric motor, which are used in a control mode to monitor the other drive electronics unit in an active mode by calibrating a motor speed and/or a current value and/or voltage value supplied by the other drive unit to the motor connection.

7. The drive system according to claim 3, wherein, in the fault-free state of the drive system, one drive electronics unit is in the active mode and the other drive electronics unit is in the control mode.

8. The drive system according to claim 1, wherein the motor connection comprises a plurality of cables, which are connected to a respective phase of the electric motor.

9. The drive system according to claim 1, wherein the electric motor is a permanent magnet synchronous motor or a brushless DC motor.

10. The drive system according to claim 1, wherein the damping unit is designed to short-circuit the phases of the electric motor in order to generate a resistance to a rotary movement of the electric motor.

11. The drive system according to claim 1, wherein the damping unit is designed to switch the phases of the electric motor to an electrical or electronic load in order to generate a resistance to a rotary movement of the electric motor.

12. The drive system according to claim 1, wherein the damping unit is integrated in the electric motor.

13. An electromechanical actuator having the drive system according to claim 1.

14. The electromechanical actuator according to claim 13, wherein the electromechanical actuator is designed for use in a primary flight control of an aircraft.

15. An aircraft having the electromechanical actuator according to claim 13.

16. The drive system according to claim 3, wherein, in the control mode, the first drive electronics unit monitors a state of the electric motor and/or the second drive electronics unit.
